(19) United States
(12) Patent Application Publication
(10) Pub. No.: US 2014/0313381 A1
(43) Pub. Date: Oct. 23, 2014

(54) IMAGE PICKUP APPARATUS

(71) Applicant: CANON KABUSHIKI KAISHA, Tokyo (JP)

(72) Inventor: Shingo Isobe, Saitama-shi (JP)

(73) Assignee: CANON KABUSHIKI KAISHA, Tokyo (JP)

(21) Appl. No.: 14/255,022

(22) Filed: Apr. 17, 2014

(30) Foreign Application Priority Data
Apr. 19, 2013 (JP) 2013-088025

(51) Int. Cl. H04N 5/353; H04N 5/376; H04N 5/217; H04N 5/378

(52) U.S. Cl. CPC H04N 5/353; H04N 5/378; H04N 5/3765; H04N 5/2173
USPC 348/297

(57) ABSTRACT

An image pickup apparatus includes: an interest area setter configured to input a signal in order to set plurality of interest areas within an image pickup area of an image sensor; a readout area setter configured to set a readout area to read out an image signal from the image sensor so as to maintain shapes of the respective interest areas in an image formed by an image signal to be output; a sensor readout controller configured to control readout of a pixel signal of the readout area from the image sensor; and an output signal generator configured to generate the image signal to be output based on the pixel signal read out by the sensor readout controller.

### BACKGROUND OF THE INVENTION

1. Field of the Invention

The present invention relates to an image pickup apparatus, and more particularly, to an image pickup apparatus having a partial readout function.

2. Description of the Related Art

In production lines of factories, image pickup apparatus for image input have been used instead of visual inspection by a human inspector. Those image pickup apparatus are also called machine vision cameras, which are used for inspecting various components and products together with a computer or a digital input/output apparatus. In recent years, in order to improve the inspection accuracy, an image pickup apparatus including ten-million or more pixels has been used.

When such an image pickup apparatus is used to take moving images and read out signals from all of the pixels in the pixel arrays, the number of pixels is large, and hence a long period of time is necessary to read out the signals from the pixel arrays. This reduces the number of images to be taken per second. Further, the amount of data of the taken image to be output to an external portion increases, and hence the frame rate decreases. As described above, in the machine vision camera, the total period of time for readout changes depending on the number of pixels for image pickup, and the frame rate changes depending on the number of pixels to be transmitted to a portion external to the image pickup apparatus as an image.

In view of this, in Japanese Patent Application Laid-Open No. H09-214836, there is proposed a technology of reducing a time period to read out signals from pixel arrays by performing so-called thinning-readout of specifying a part of the pixel arrays as an interest area and reading out only the interest area. According to this technology, the number of images to be taken per second is increased. Further, the amount of data of the taken image to be output to the external portion reduces to increase the frame rate. Such thinning-readout can be set dynamically, and the frame rate changes depending on the number of pixels that are read out and the amount of data to be output to the external portion.

Further, in Japanese Patent Application Laid-Open No. 2009-027559, when a plurality of interest areas exist, thinning-readout of respective pixel arrays is performed. According to this technology, a specified interest area is read out, and a user can efficiently acquire a desired image.

However, in the related art described above, one of the interest area locations is displayed. Further, for cases where an arbitrary number of interest areas can be specified, and for cases where a plurality of interest areas are set, images associated with the interest areas are output externally. In particular, for cases where there is a plurality of interest areas and the horizontal and vertical positions of each interest area differ, continuity of the interest areas in an output image may be lost. The output image becomes serialized data, and thus by using the related art disclosed by Japanese Patent Application Laid-Open No. H09-214836 or Japanese Patent Application Laid-Open No. 2009-027559, the user receives an image where the continuity of each interest area is lost. It thus becomes difficult to perform image restoration after receiving image data.

### SUMMARY OF THE INVENTION

An object of the present invention is to reduce blank areas of output image data as much as possible when partial readout areas are specified, and to generate an image signal in which partial readout areas may be easily found, in a partial readout capable image pickup apparatus.

According to one embodiment of the present invention, there is provided an image pickup apparatus including: an interest area setter configured to input a signal in order to set a plurality of interest areas within an image pickup area of an image sensor; a readout area setter configured to set a readout area from which an image signal is read out from the image sensor so as to maintain shapes of the respective interest areas in an image formed by an image signal to be output; a sensor readout controller configured to control readout of a pixel signal of the readout area from the image sensor; and an output signal generator configured to generate the image signal to be output based on the pixel signal read out by the sensor readout controller.

According to one embodiment of the present invention, in the partial readout capable image pickup apparatus, the blank areas of output image data can be reduced as much as possible so that reductions in rate of data sent to an external portion from the image pickup apparatus can be kept to a minimum, and the image signal in which the partial readout areas are easily found can be generated while maintaining the shapes of images read out from the plurality of interest areas.

Further features of the present invention will become apparent from the following description of exemplary embodiments with reference to the attached drawings.

### BRIEF DESCRIPTION OF THE DRAWINGS

FIG. 1 is a configuration diagram in a first embodiment of the present invention.

FIG. 2 is an image sensor in the first embodiment.

FIG. 3 is an image pickup composition diagram in the first embodiment.

FIG. 4 is a taken image in the first embodiment.

FIG. 5 is an interest area setting example in the first embodiment.

FIG. 6 is an explanatory diagram for sensor accumulation control and readout control.

FIG. 7 is a timing chart (line V101) in the first embodiment.

FIG. 8 is a timing chart (line V201) in the first embodiment.

FIG. 9 is a timing chart (line V401) in the first embodiment.

FIG. 10 is a timing chart (line V901) in the first embodiment.

FIG. 11 is readout data in the first embodiment.

FIG. 12 is a timing chart (horizontal direction skip in reading) in the first embodiment.

FIG. 13 is an example of application to a Camera Link standard in the first embodiment.

FIG. 14 is a timing chart (Camera Link application example) in the first embodiment.

FIG. 15 is an example where an interest area readout data positional relationship is nonconforming.

FIG. 16 is a configuration diagram in a second embodiment of the present invention.

FIG. 17 is a timing chart (line V101) in the second embodiment.

FIG. 18 is a timing chart (line V201) in the second embodiment.

FIG. 19 is a timing chart (line V301) in the second embodiment.

FIG. 20 is a timing chart (line V501) in the second embodiment.

FIG. 21 is a timing chart (line V601) in the second embodiment.

FIG. 22 is a timing chart (line V801) in the second embodiment.

FIG. 23 is an image signal in the second embodiment.

FIG. 24 is a configuration diagram in a third embodiment of the present invention.

FIG. 25 is a flowchart in the third embodiment.

FIG. 26 is an image signal in the third embodiment.

FIG. 27 is an interest area in the third embodiment.

FIG. 28 is an image signal 2 in the third embodiment.

FIG. 29 is an image signal 3 in the third embodiment.

### DESCRIPTION OF THE EMBODIMENTS

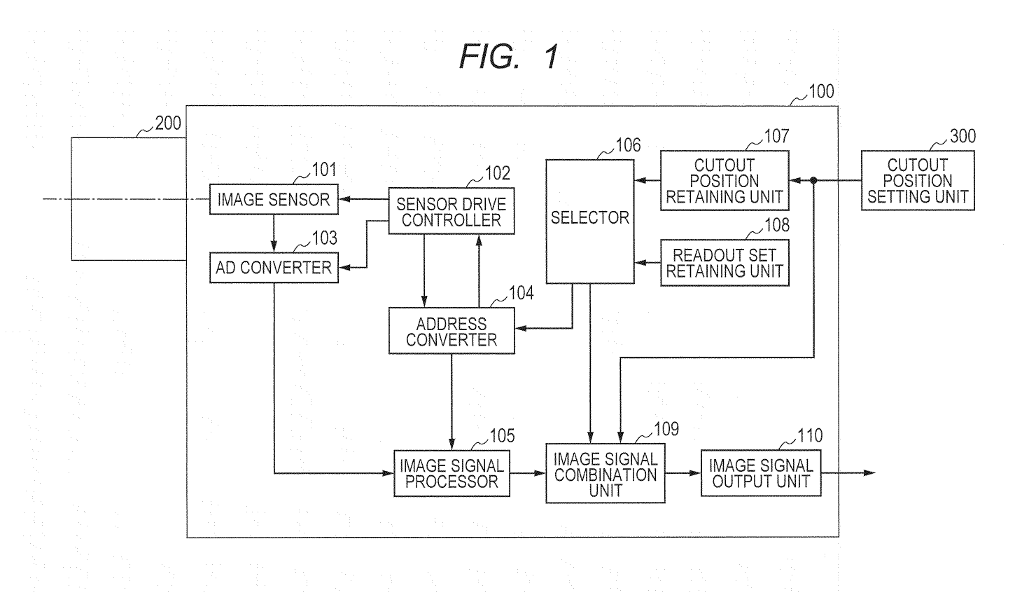

Now, exemplary embodiments of the present invention are described in detail with reference to the accompanying drawings. FIG. 1 is a configuration diagram according to an embodiment of the present invention.

### First Embodiment

FIG. 1 is a configuration diagram of an image pickup apparatus according a first embodiment of the present invention. An image pickup apparatus 100 includes an image pickup system including an image sensor 101, and performs image pickup processing by a sensor drive controller 102, an AD converter 103, and an address converter 104. A lens 200 is configured in an external portion of the image pickup apparatus 100, and light flux that passes through the lens 200 forms an image on the image sensor 101 of the image pickup apparatus 100. The lens 200 includes a stop, a focus lens group, and the like (not shown). Further, a zoom lens group including the lens 200 may have a variable or a fixed focal length.

The sensor drive controller 102 controls an electric charge accumulation operation and a readout operation of the image sensor 101. When the sensor drive controller 102 performs the image pickup processing of the image sensor 101, an image pickup signal is output from the image sensor 101, which undergoes A/D conversion by the AD converter 103. The address converter (readout area setter) 104 calculates, based on setting data from a selector 106 described later, an address of a pixel of the image sensor 101 to be subjected to accumulation control and readout control by the sensor drive controller 102 (sensor readout controller). When performing so-called thinning-readout from the image sensor 101 by selecting and reading out from selected pixels, and not reading out from every pixel, addresses for only those pixels selected for readout are output from among all of the pixels of the image sensor 101, and addresses for pixels not selected for readout are skipped. An image signal processor 105 inputs image pickup signal data from the AD converter 103 and signals from the address converter 104, and provides a frame synchronizing signal, a vertical synchronizing signal, a horizontal synchronizing signal, and the like with respect to the image pickup signal data.

A cutout position setting unit (interest area setter) 300 inputs and sets coordinate data for an area containing necessary image data within the image pickup area of the image sensor (hereinafter referred to as “interest area”) from the external portion of the image pickup apparatus 100. For example, a cutout position may be set in the cutout position setting unit 300 using communication means from a PC or the like.

A cutout position retaining unit 107 retains setting data input by the cutout position setting unit 300. A readout set retaining unit 108 retains range setting values for accumulating and reading out all pixels of the image sensor 101.

The selector 106 inputs setting data from the cutout position retaining unit 107 and the readout set retaining unit 108, and selects any one of the setting data. The setting data selected by the selector 106 is passed to the address converter 104.

An image signal combination unit 109 generates an output image signal by adding necessary image data to the image pickup signal data output from the image signal processor 105 so that conformity of the coordinates of each interest area of the image pickup signal is achieved with a readout area selected by the selector 106. An image signal output unit 110 outputs the output image signal generated by the image signal combination unit 109 to a portion external to the image pickup apparatus 100.

The image signal processor 105 and the image signal combination unit 109 constitute an output signal generator. Based on information on the pixel data read out from the image sensor 101, the readout area, the interest area, the above-mentioned various synchronizing signals, and the like, the output signal generator generates the output image signal to be output to a portion external to the image pickup apparatus 100.

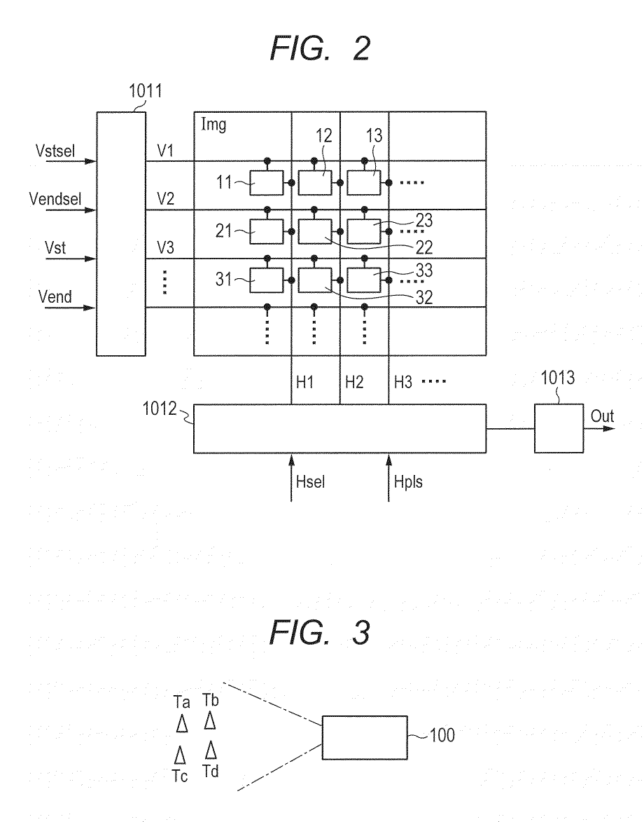

The configuration of the image sensor 101 is illustrated in FIG. 2. Img in FIG. 2 represents an image pickup element. A portion of a pixel array configuring Img is represented by pixels 11 to 33 in FIG. 2. Each pixel within Img is connected to a vertical circuit 1011 and a horizontal circuit 1012 through V1, V2, V3, . . . , and H1, H2, H3, . . . , respectively. Vstsel and Vendsel for selecting an accumulation start object and an accumulation complete object among the respective lines in Img and Vst and Vend for providing triggers for start and completion of accumulation are connected to the vertical circuit 1011. When triggers are input through Vstsel and Vendsel, reference lines (V1, V2, V3, . . . ) of the image sensor 101 are incremented. Further, similarly, Hsel for selecting pixels in the horizontal direction of the lines selected by Vendsel and Hpls for providing readout pulses are connected to the horizontal circuit 1012. Similarly to Vstsel and Vendsel, when triggers are input through Hsel and Hpls, reference pixels in the lines (V1, V2, V3, . . . ) selected by Vstsel are incremented. Vstsel, Vendsel, Vst, Vend, Hsel, and Hpls are control signals to be input from the sensor drive controller 102 of FIG. 1. When pulses are input to Hpls for readout control, through an amplifier 1013 of FIG. 2, an analog image pickup signal is output from Out. This image pickup signal is connected to the AD converter 103 of FIG. 1. The AD converter 103 performs A/D conversion on the image pickup signal input to the AD converter 103 in synchronous with Hpls.

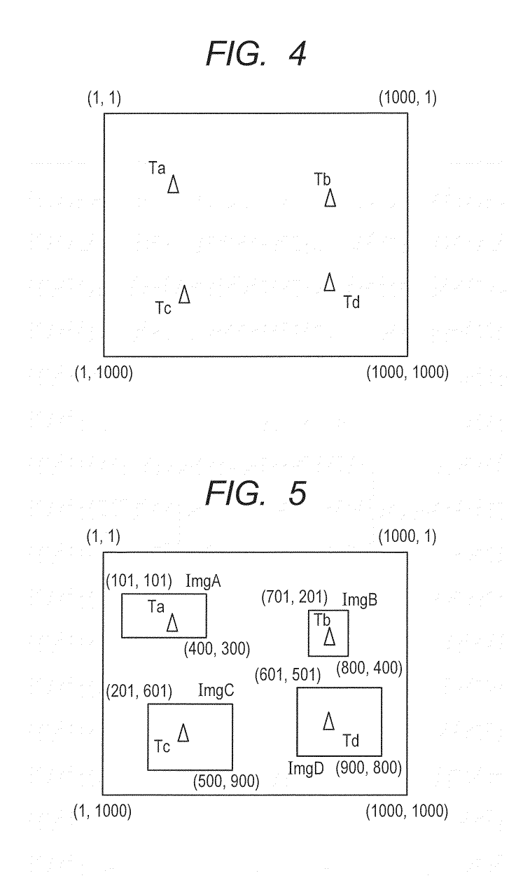

FIG. 3 is a composition diagram of imaging image pickup targets Ta, Tb, Tc, and Td with use of the image pickup apparatus 100 of the present invention. The dashed-dotted lines of FIG. 3 represent an angle of view of the image pickup apparatus 100. FIG. 4 illustrates an image taken at this time. In this embodiment, an example is described in which thinning-readout is performed in a taken image illustrated in FIG. 4 with four areas containing the image pickup targets Ta, Tb, Tc, and Td as interest areas. A case where the number of interest areas is 4 is exemplified, but the present invention is similarly applicable to a case where a plurality of interest areas is set. Note that, in this embodiment, a case where the number of pixels of the taken image is 1,000 pixels in width by 1,000 pixels in height is exemplified for description, but the number of pixels of the taken image is not limited thereto. In the following, for simplifying the description, the position inside the taken image is represented by orthogonal XY coordinates (X, Y). In the figures, a right direction in a left-right (horizontal) direction is referred to as “X direction”, and a downward direction in an up-down (vertical) direction is referred to as “Y direction”. In this embodiment, description is made supposing that the coordinates at the upper left of the taken image are (1, 1), and the coordinates at the lower right are (1000, 1000).

In this embodiment, description is made of a partial readout method (selective readout method) of a case where, as illustrated in FIG. 5, four interest areas (ImgA, ImgB, ImgC, and ImgD) are set by the cutout position setting unit 300 of FIG. 1 with respect to the four image pickup targets Ta, Tb, Tc, and Td, respectively.

The interest areas ImgA, ImgB, ImgC, and ImgD are areas containing the image pickup targets Ta, Tb, Tc, and Td, respectively. By providing coordinates at the upper left and the lower right of each of the areas, the interest area is defined. In FIG. 5, the interest area ImgA is a rectangular area surrounded by (101, 101) at the upper left and (400, 300) at the lower right. The interest area ImgB is a rectangular area surrounded by (701, 201) at the upper left and (800, 400) at the lower right. The interest area ImgC is a rectangular area surrounded by (201, 601) at the upper left and (500, 900) at the lower right. The interest area ImgD is a rectangular area surrounded by (601, 501) at the upper left and (900, 800) at the lower right. The cutout position setting unit 300 may include a computer or a setting unit (not shown), or for example, may include a setting unit including a mouse, a joy stick, and other input units connected to the image pickup apparatus.

In this embodiment, readout of pixel data is performed with respect to the interest areas set as illustrated in FIG. 5, and skip in reading is performed with respect to a part other than the interest areas, to thereby reduce the pixel data readout time period. However, if reading is skipped in all of the areas other than the interest areas, and the number of pixels read out is optimized to a minimum, image signal conformity for each interest area is not achieved. That is, when image signals for each output horizontal direction line are reconstituted as one image, there is a possibility that an image may be formed where the original shapes of each of the set interest areas are not maintained. In the following description, “interest area image signal conformity is not achieved” indicates that the shape of an interest area changes in an image reconstituted based on output image signals. In this embodiment, an example of increasing the frame rate by skipping in reading as many skip-able pixels as possible while achieving conformity of the image signals of each interest area is shown. Specifically, in this embodiment, an example of reducing the readout amount at areas other than interest areas ImgA to ImgD, while maintaining the shape of the respective interest areas ImgA to ImgD, is described.

Referring back to the description of FIG. 5, when the coordinates of each of the interest areas ImgA, ImgB, ImgC, and ImgD are set by the cutout position setting unit 300 of FIG. 1 as illustrated in FIG. 5, the cutout position retaining unit 107 retains the setting coordinates of each of the interest areas.

The selector 106 selects any one of the setting value of the cutout position retaining unit 107 and the setting value of the readout set retaining unit 108. For cases where an interest area is not set by the cutout position setting unit 300, the selector 106 selects the setting value retained by the readout set retaining unit 108 and operates in an all pixel readout mode. Further, when an interest area is set by the cutout position setting unit 300, the selector 106 selects the setting value of the interest area retained by the cutout position retaining unit 107 and operates in a partial readout mode. As illustrated in FIG. 5, the interest areas ImgA to ImgD are set here by the cutout position setting unit 300, and the selector 106 therefore selects the setting value of the cutout position retaining unit 107 and operates in the partial readout mode.

Next, based on the information on the interest area selected by the selector 106, the address converter 104 outputs, to the sensor drive controller 102, a line number and a pixel number corresponding to address information for performing accumulation and readout of the image sensor 101. The address converter 104 obtains minimum value X-coordinate and Y-coordinate points (Xmin, Ymin) and maximum value X-coordinate and Y-coordinate points (Xmax, Ymax) from all coordinates of interest areas ImgA to ImgD. That is, from FIG. 5, the following can be computed.
(Xmin, Ymin)=(101, 101)
(Xmax, Ymax)=(900, 900)

Further, thinning addresses portions that do not exist in the interest areas are computed in the horizontal direction and in the vertical direction. That is, areas where X-coordinate values are not contained in the X-coordinate range of any of the interest areas, and areas where Y-coordinate values are not contained in the Y-coordinate range of any of the interest areas, are computed as thinning addresses. Based on the above-mentioned ranges in the entire screen (1, 1) to (1000, 1000), horizontal lines (vertical direction (Y direction) positions) that can be thinned are lines V1 to V100, lines V401 to V500, and lines V901 to V1000. Further, pixels (horizontal direction (X direction) positions) that can be thinned are 1st to 100th pixels, 501st to 600th pixels, and 901st to 1,000th pixels. Readout is performed while thinning those lines and horizontal direction pixels (addresses) (those lines and horizontal direction pixels (addresses) are skipped in reading and other pixels are read out).

Address output processing is performed by the address converter 104 of FIG. 1 in synchronous with line control of the image sensor 101 by the sensor drive controller 102. Once line control by the sensor drive controller 102 is completed, address information for controlling the next line is updated and output.

Details of a method of controlling the image sensor 101 by the sensor drive controller 102 of FIG. 1 are described here.

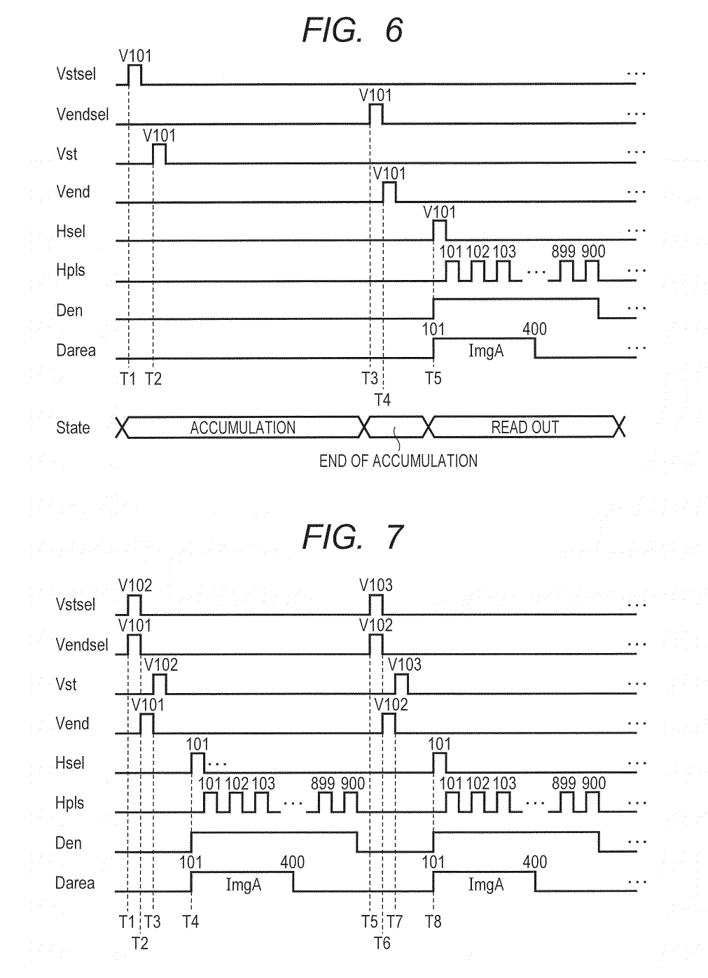

Based on interest area information, the address converter 104 outputs line and pixel numbers to the sensor drive controller 102 in order to perform accumulation and reading out of the image sensor 101. The sensor drive controller 102 controls the image sensor 101 and the AD converter 103 based on address information for control object lines and pixels input from the address converter 104. FIG. 6 illustrates a timing chart that illustrates an example of accumulation control and readout control of a first line V101 of the image sensor 101 (hereinafter referred to as line V101) by the sensor drive controller 102. As illustrated in FIG. 2, each control line Vstsel, Vendsel, Vst, Vend, Hsel, and Hpls is connected from the sensor drive controller 102 to the vertical circuit 1011 and the horizontal circuit 1012 of the image sensor 101.

The interest areas illustrated in FIG. 5 are set, and therefore by setting Vstsel to high (hereinafter abbreviated as “Hi”) at T1 of FIG. 6, the vertical circuit 1011 selects the line V101 of the image sensor 101 as an accumulation start object. Note that, Ymin is 101, and thus lines V1 to V100 are pixel lines not subject to pixel data readout here. Therefore, a necessary number of pulses are output from the sensor drive controller 102 to Vstsel before T1, an object line number is already incremented, and the line V101 is selected.

Next, at T2, Vst is set to Hi, and the vertical circuit 1011 begins accumulation operations of the line V101 of the image sensor 101. Vendsel is set to Hi at T3, and the vertical circuit 1011 selects the line V101 of the image sensor 101 as an accumulation complete object. Next, at T4, Vend is set to Hi and the vertical circuit 1011 completes accumulation operations of the line V101. At this point, electric charges accumulated at the line V101 are output to the horizontal circuit 1012 through H1, H2, H3, . . . of FIG. 2. Next, Hsel is set to Hi at T5, selecting a 101st pixel of the line V101. Further, a pulse is input to Hpls at the same time. An image signal from the 101st pixel of the line V101 is output from the horizontal circuit 1012 through the amplifier 1013 in synchronous with a rising edge of Hpls. At this point, Hpls output from the sensor drive controller 102 is input to the AD converter 103 of FIG. 2. An analog image signal output from the image sensor 101 undergoes A/D conversion in the AD converter 103 one pixel at a time also in synchronous with Hpls.

During a period when Den of FIG. 6 is Hi, image data is read out and output. In the example of FIG. 6, a period from T5 onward shows that pixel signals from the 101st to the 400th pixel of the line V101 are read out due to the Hi signal of Darea. Then, when clock output is completed up through Hpls reaching the 900th pixel (corresponding to a right edge of the interest area ImgD), readout of the line V101 is complete. By sequentially and repeatedly performing the series of processes illustrated in FIG. 6, accumulation and readout of each line can be performed.

Further, accumulation and readout may be performed as so-called pipe line processing by applying the electric charge accumulation to the pixels and the pixel data readout illustrated in FIG. 6.

FIG. 7 illustrates a timing chart for performing accumulation of the line V102 and performing readout control of the pixel data of the line V101 in parallel after completion of accumulation of the line V101 of the interest area ImgA. The timing chart of FIG. 7 illustrates a period after accumulation of the line V101 has started. Regarding the start of accumulation of the line V101, after Vstsel is set to Hi and the line V101 is selected as illustrated in FIG. 6, setting Vst to Hi starts accumulation of the selected line V101. At T1 in FIG. 7, Vstsel is set to Hi, thus selecting the image sensor 101 as an accumulation start object. As described above, accumulation of the line V101 begins prior to T1. By setting Vendsel to Hi at T1, the line V101 of the image sensor 101 for which accumulation has already started is selected as an accumulation complete object. Next, by setting Vend to Hi at T2, accumulation operations of the selected line V101 stop. At this point, the electric charges accumulated in the line V101 are transferred to the horizontal circuit 1012 through H1, H2, H3, . . . of FIG. 2. Next, at T3, Vst is set to Hi, thus starting accumulation of the line V102. Next, at T4, Hsel is set to Hi, selecting the 101st pixel of the line V101. Further, at the same time and in synchronous with pulse input to Hpls, a pixel signal from the 101st pixel of the line V101 is output from the horizontal circuit 1012 through the amplifier 1013. At this point, Hpls output from the sensor drive controller 102 is input to the AD converter 103 of FIG. 2. In synchronous with Hpls, an analog pixel signal output from the image sensor 101 undergoes A/D conversion one pixel at a time in the AD converter 103. A period when Den in FIG. 7 is Hi indicates that pixel data is read out and output, while a period when Darea is Hi indicates that pixels corresponding to the interest areas, from among the output data indicated by Den, are output. The example of FIG. 7 represents that, at T4, first line pixel signals of the interest area ImgA are read out from the 101st pixel to the 400th pixel of the line V101. When clock output by Hpls up through the 900th pixel is completed, next from T5 to T7 in FIG. 7, accumulation of the line V102 of the image sensor 101 is stopped, accumulation of the line V103 starts, and readout of the line V102 starts, similarly to that described above. Readout of the second line V102 of the interest area ImgA is performed similarly from T8 onward. With the method illustrated in FIG. 7, after readout up through the line V200 is performed, readout from the two interest areas ImgA and ImgB is performed for the line V201 onward.

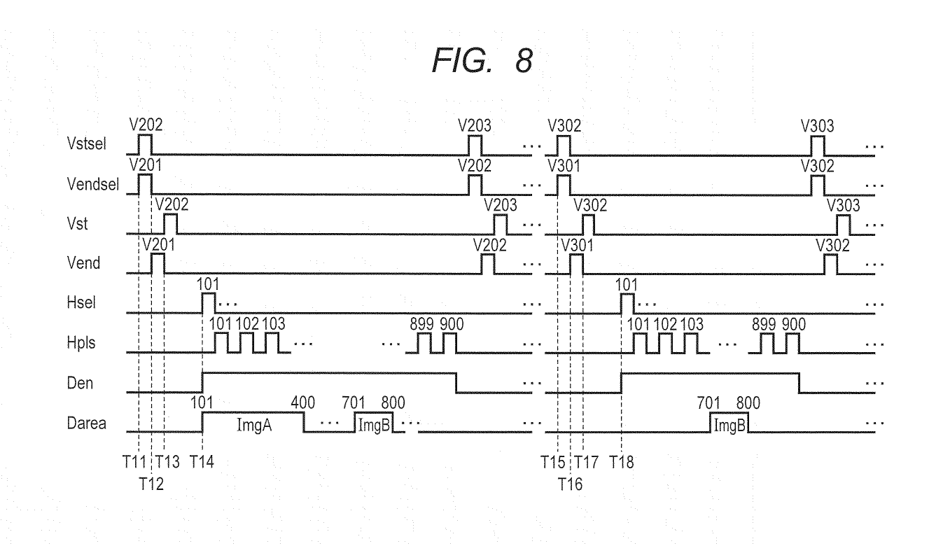

FIG. 8 illustrates a timing chart that illustrates a readout method from the line V201 of the image sensor 101 onward. Accumulation and readout methods are similar to the methods illustrated in FIG. 7. The example illustrated in FIG. 8 also illustrates a timing chart for a state where accumulation of the line 201 has already started. First, at T11, setting Vstsel to Hi selects the line V202 as an accumulation object, and setting Vendsel to Hi selects the line V201 as an accumulation complete object. Next, at T12, setting Vend to Hi completes accumulation of the selected line V201. Electric charges accumulated in the line V201 are then transferred to the horizontal circuit 1012 of FIG. 2. Next, at T13, setting Vst to Hi starts accumulation of the line V202. At T14, setting Hsel to Hi selects to read out pixel signals from the 101st pixel of the line 201, skipping reading of pixels from the 1st to the 100th pixel. Further, by starting clock input to Hpls, an image pickup signal is output from the image sensor 101 (the amplifier 1013) in synchronous with Hpls. At this point, the output of Den is similar to that of FIG. 7. In accordance with the output of Darea, ImgA is read out from the 101st pixel to the 400th pixel, and a pixel signal corresponding to ImgB is read out from a 701st pixel to an 800th pixel. In FIG. 8, accumulation and readout similar to those described above are repeatedly implemented up through the line V300. When readout is completed up through the line V300, at T15, accumulation of the line V302 starts, accumulation of the line V301 is stopped and readout thereof is started. At T18 and onward in FIG. 8, from among the data read out from the horizontal circuit, pixel signals from the 701st pixel to the 800th pixel correspond to the interest area ImgB. Pixel signals corresponding to the interest area ImgB are similarly read out. When readout up through the line V400 is complete, lines from the line V401 capable of being thinned become a processing object, as described above.

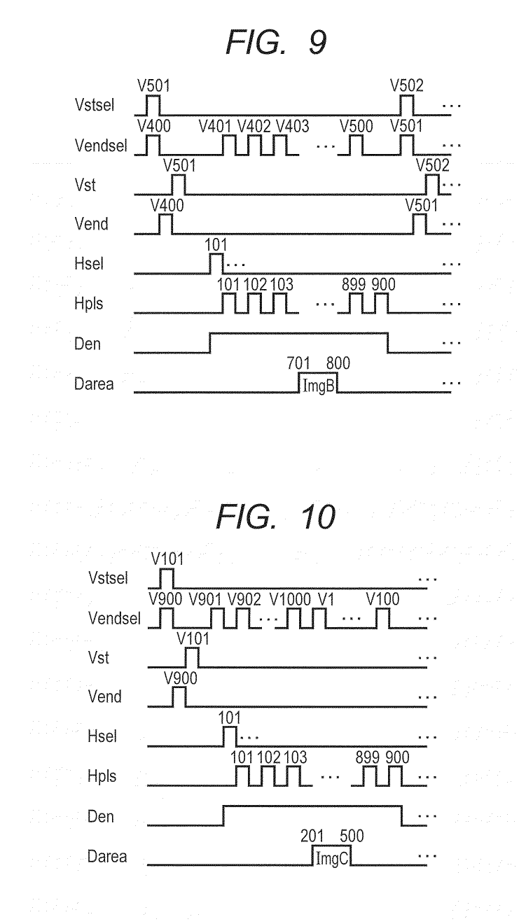

FIG. 9 illustrates a timing chart that illustrates an accumulation and readout method from the line V400 to the line V500 of the image sensor 101. In FIG. 9, similarly to FIG. 7 and FIG. 8, accumulation of the line V400 is stopped to read out pixel signals, and accumulation of the line V501 starts. In FIG. 9, by inputting a plurality of pulses to Vendsel in parallel with reading out pixel signals of the line V400, the accumulation complete object line is incremented, and operations progress from the line V401 to the line V500. So-called skip in reading is thus performed from the line V401 to the line V500. The frequency of the pulses input to Vendsel may differ from the pulse frequency of Hpls as long as increments of Vendsel can progress up to V500 by the time when readout of the line V400 is complete. When readout of the line V400 stops, accumulation of the line V501 described above is stopped, and accumulation of the line V502 is started. By performing skip in reading in a V direction as in FIG. 9, the amount of time for accumulation and readout from the line V401 to the line V500 can be reduced.

While readout of pixel data of the line V400 is performed in order from the pixel number 101, Darea is Hi at a timing corresponding to pixel numbers 701 to 800, which represents pixel data of the interest area ImgB.

Accumulation control and readout from the line V501 to the line V900 of FIG. 5 is performed hereafter similarly to those of FIG. 7 to FIG. 9. Lines from the line V901 then become skip-in-reading object lines. FIG. 10 illustrates a timing chart that illustrates a skip in reading method for lines from the line V901. In the timing chart of FIG. 10, similarly to that of FIG. 9, accumulation of the line V900 is stopped to read out pixel signals, and accumulation of the line V101 starts. In FIG. 10, similarly to FIG. 9, during readout from the pixel signals 101 to 900 of the line V900, multiple pulses are input to Vendsel. The accumulation complete object line is then incremented, and operations progress from the line V901 to the line V1000, and in addition progress from the line V1 to the line V100. Vendsel is selected up through the line V1000, and is again selected from the line V1. Skip in reading is thus performed from the line V901 to the line V1000, and from the line V1 to the line V100.

During a period during which readout of pixel data of the line V900 is performed in order from the pixel signal 101, Darea is Hi at a timing corresponding to pixel numbers 201 to 500, which represents pixel data of the interest area ImgC.

The sensor drive controller 102 of FIG. 1 thus performs accumulation and readout control of the image sensor 101 in accordance with the timing charts illustrated from FIG. 7 through FIG. 10, and pixel signals are output through the AD converter 103. A digitized pixel signal is obtained from the AD converter 103, and input to the image signal processor 105. In the image signal processor 105, pixel number information is input from the address converter 104 with respect to pixel signals read out in order from the image sensor 101, and a frame synchronizing signal, a vertical synchronizing signal, and the like, for the pixel signals obtained are provided to the pixel signals. The pixel signals are next output to the image signal combination unit 109.

The image signal combination unit 109 of FIG. 1 refers to Darea of the timing charts illustrated from FIG. 7 through FIG. 10. When Darea is Hi, an interest area image signal is obtained, and hence bypass output is performed. Further, when Darea is low (hereinafter abbreviated as “Lo”), an image signal for an area other than the interest area is obtained, and hence the output is replaced with a black level image signal as dummy data.

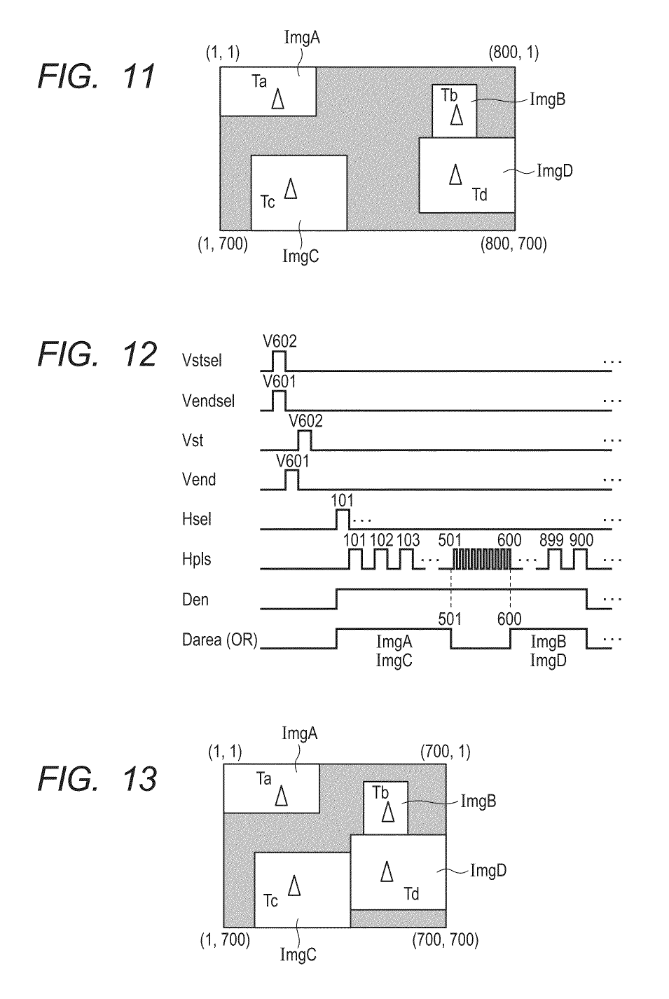

Image signals output from the image signal combination unit 109 of FIG. 1 are output to a portion external to the image pickup apparatus 100 from the image signal output unit 110. FIG. 11 illustrates an image signal output from the image signal output unit 110. As described above, the lines V1 to V100, the lines V401 to V500, and the lines V901 to V1000 are skipped in reading. Accordingly, as illustrated in FIG. 11, an image signal is generated in which areas where the X-coordinate value is less than the minimum X-coordinate value or greater than the maximum X-coordinate value of any of the interest areas, and areas where the Y-coordinate value is not contained within the Y-coordinate range of any of the interest areas are thinned (removed). The image size at this point becomes 800 pixels in width by 700 pixels in height, and therefore the time necessary to read out 60,000 pixels can be eliminated compared to reading out all of the pixels at a width of 1,000 and a height of 1,000. At the same time, conformity of the positional relationships of the interest areas ImgA through ImgD is maintained (the shapes of individual interest areas are maintained).

In this embodiment, each of the interest areas is taken together as one block, and (Xmin, Ymin) and (Xmax, Ymax) are thus found from all the coordinates of the interest areas. In addition, in the horizontal direction and in the vertical direction, by performing address computations while thinning portions where the interest areas do not exist, conformity of the positional relationships between the interest areas is maintained, and the amount of readout time can be reduced.

Further, this embodiment, as illustrated in FIG. through FIG. 10, shows an example of inserting and outputting dummy data to an area between ImgA and ImgB and to an area between ImgC and ImgD in the horizontal direction. On the other hand, as shown by a timing chart of FIG. 12, by speeding up Hpls from the 501st pixel to the 600th pixel, skip in reading can be performed in practice. The 501st pixel to the 600th pixel in the horizontal direction define an area not present in any of the interest areas from ImgA to ImgD in the horizontal direction. When Hpls is speeded up, there is a danger that conformity may not be achieved between timing of A/D conversion performed by the AD converter 103 and pixel signals read out from the image sensor 101. However, in areas originally outside of the areas of interest, not achieving data conformity may not be problematic for a user.

FIG. 13 illustrates image signals read out using the timing chart illustrated in FIG. 12. In addition to skip in reading of the lines V1 to V100, the lines V401 to V500, and the lines V901 to V1000 as described above, it becomes possible to perform thinning in the horizontal direction from the 501st pixel to the 600th pixel. That is, in the horizontal (X) direction and in the vertical (Y) direction, it becomes possible to compute portions where the interest areas do not exist, and then to remove areas where the X-coordinate value is not contained within the X-coordinate range of any of the interest areas, and to remove areas where the Y-coordinate value is not contained within the Y-coordinate range of any of the interest areas.

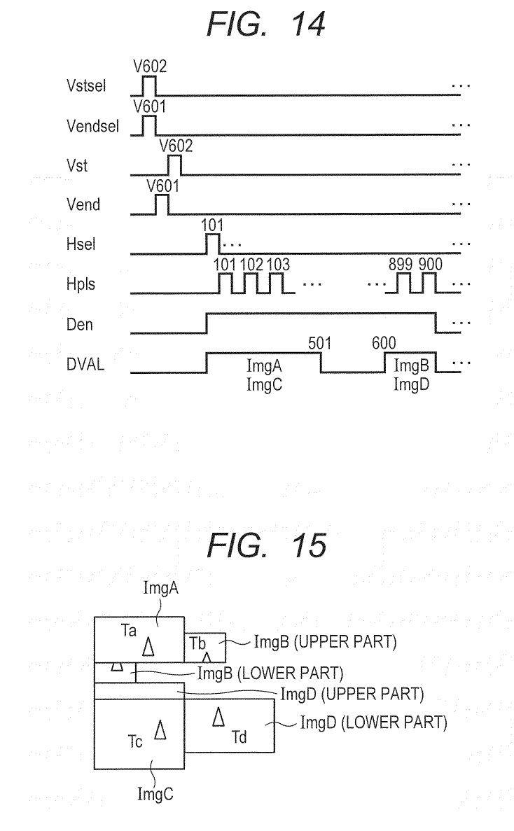

Further, a standard exists called CameraLink that is often used in machine vision. By preparing an interface board called a frame grabber corresponding to the CameraLink standard, an image signal can be received using a general purpose PC. With the CameraLink standard, even if an image signal is output, the output image signal can be made invalid by setting a signal called DVAL to Lo. For example, as the timing chart of FIG. 14, when all lines are read out, DVAL is set to Lo from the 501st pixel to the 600th pixel. An image signal obtained via a frame grabber can thus be the image signal illustrated in FIG. 13 described above. In addition to removing unnecessary data outside of the interest areas, an image signal thus obtained can obtain conformity of positional relationships between the interest areas specified by the user (the shapes of each interest area can be maintained), and an image signal that is readily manageable for the user can be obtained.

FIG. 15 illustrates image signals obtained when only specified interest areas are read out. In FIG. 15, image signals in the horizontal direction in the interest areas ImgB and ImgD are reduced, and hence conformity of the positional relationships of the interest areas is broken (the shape of each of the interest areas cannot be maintained). With the present invention, image signals are output in a state where the shape and direction of each of the interest areas is maintained (in a state where each of the interest areas is displayed in its original shape when the output image signal is recreated as an image), as illustrated in FIGS. 11 and 13. Further, an image signal is output in a state where the relative size relationships between the interest areas are maintained.

The readout area setter sets, as the readout area, a region surrounded by the minimum and maximum X-coordinate values, and by the minimum and maximum Y-coordinate values, which are computed from coordinates of each of the interest areas in a predefined orthogonal XY coordinate system.

The readout area setter sets, as the readout area, an area excluding an area where the X-coordinate value is not contained within the X-coordinate range of any of the interest areas and an area where the Y-coordinate value is not contained within the Y-coordinate range of any of the interest areas, based on the coordinates of each of the interest areas.

By thus applying the present invention to the plurality of interest areas, positional conformity between the interest areas can be maintained, the amount of readout image signals can be reduced, and the user can efficiently obtain a desired image.

### Second Embodiment

In the first embodiment, an example has been described in which each of the interest areas is taken together as one block, (Xmin, Ymin) and (Xmax, Ymax) are found from all the coordinates of the interest areas, and conformity of the positional relationships between the interest areas is maintained by reducing the number of pixels read out in the horizontal and vertical directions. In this embodiment, an example is shown where unnecessary data is further reduced even more than the output results of the first embodiment of FIG. 13. Specifically, an example is shown where the amount of image signal data is further reduced from the interest areas and other data in the image signals illustrated in FIG. 13.

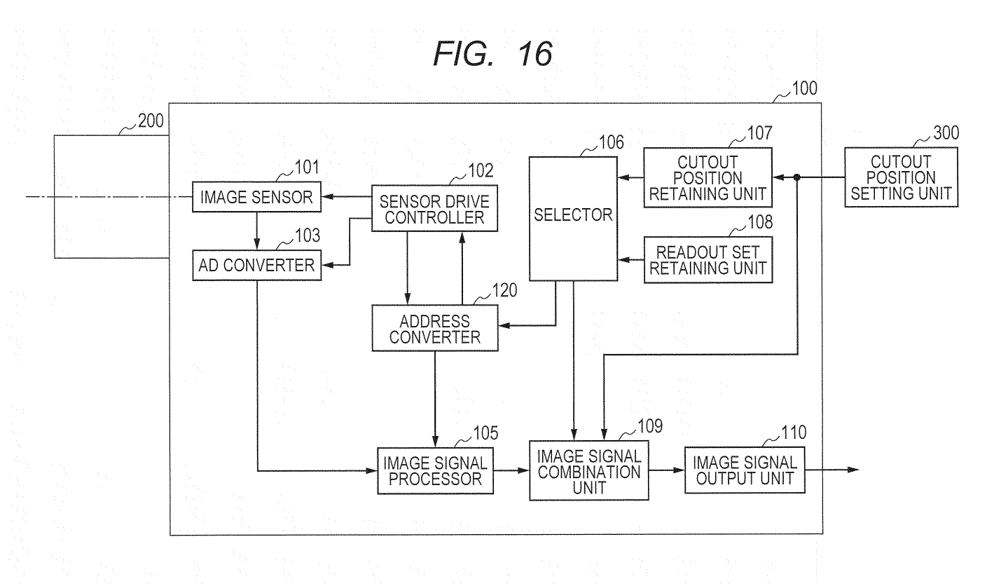

FIG. 16 illustrates a configuration diagram of an image pickup apparatus in this embodiment. The image pickup apparatus of this embodiment is similar to the configuration of the first embodiment illustrated in FIG. 1 except for an address convertor 120, and therefore explanations thereof is omitted. Using a method that differs from that of the address converter 104 of the first embodiment, the address convertor 120 computes addresses that become object pixels for the sensor drive controller 102 to perform accumulation control and readout control of the image sensor 101. The structure of the image sensor 101 is similar to that of FIG. 2 of the first embodiment, and a description thereof is thus omitted.

The image pickup composition in this embodiment is the same as that illustrated in FIG. 3 and FIG. 4 of the first embodiment, and a description thereof is thus omitted. Note that, in this embodiment, the number of pixels of a taken image is similar to that of the first embodiment, that is, a width of 1,000 pixels by a height of 1,000 pixels.

Interest areas in this embodiment are similar to those illustrated in FIG. 5 of the first embodiment. In this embodiment, each set interest area is selectively read out as in FIG. 5, and portions outside of the interest areas are skipped in reading, thus reducing the amount of readout time.

In this embodiment, a readout address range and a skip in reading address range are computed by the address convertor 120. In the image signals illustrated in FIG. 13 of the first embodiment, dummy data is embedded in the gray color areas, and this is unnecessary information for the user. In this embodiment, a skip in reading range in the horizontal direction is optimized more than the image signals illustrated in FIG. 13, thus reducing the amount of image signal data and increasing the frame rate.

Processes performed by the address convertor 120 are described. The address convertor 120 outputs line and pixel numbers, which are address information for performing accumulation and readout of the image sensor 101, to the sensor drive controller 102 based on the interest areas selected by the selector 106. The address convertor 120 extracts lines where the interest areas do not exist from all coordinates of the interest areas ImgA to ImgD. From FIG. 5, lines where the interest areas do not exist are the line V1 to the line V100, the line V401 to the line V500, and the line V901 to the line V1000. Using these results, if a logical NOT of areas where the interest areas do not exist is taken with respect to the set of all lines from the line V1 to the line V1000, the two sets of interest areas shown below are obtained from among all of the lines.

Set 1: The line V101 to the line V400

Set 2: The line V501 to the line V900

When optimization of horizontal direction skip in reading is performed with respect to each of the two sets described above, regions between the interest areas where it is possible to perform skip in reading are as follows.

Set 1: From the 401st pixel to the 700th pixel between ImgA and ImgB

Set 2: From the 501st pixel to the 600th pixel between ImgC and ImgD

Horizontal direction pixels (addresses) in the lines of Set 1 and Set 2 described above are thinned and read out. Similarly to the first embodiment, address output processing performed by the address convertor 120 of FIG. 16 is performed in synchronous with line control of the image sensor 101 by the sensor drive controller 102. Once line control by the sensor drive controller 102 is complete, address information for controlling the next line is updated and issued.

A method of controlling the image sensor 101 by the address convertor 120 and the sensor drive controller 102 of FIG. 16 is described in detail below.

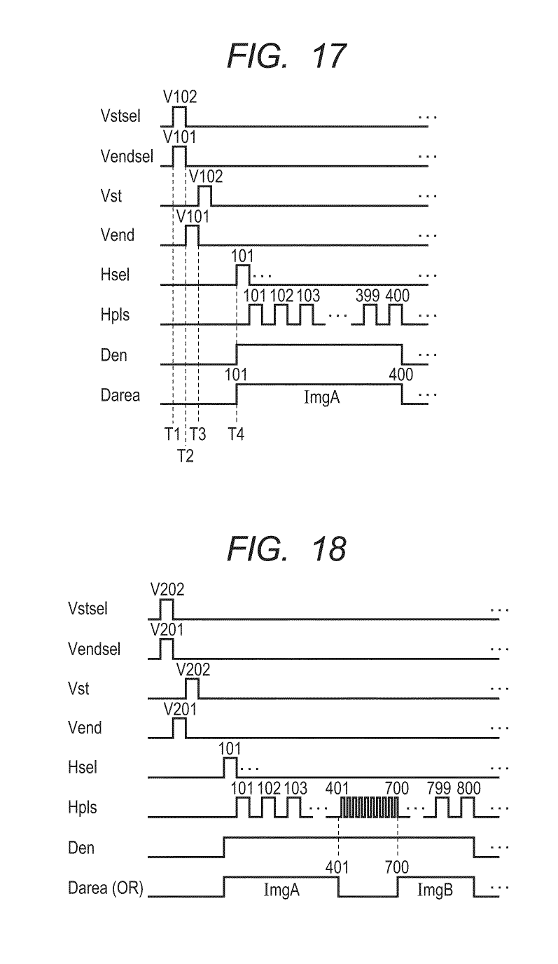

The sensor drive controller 102 controls the image sensor 101 and the AD converter 103 based on address information for control object lines and pixels input from the address convertor 120. A timing chart illustrating accumulation control and readout control of the image sensor 101 by the sensor drive controller 102 is illustrated in FIG. 17. Similarly to FIG. 7 of the first embodiment, setting Vstsel to Hi at T1 in FIG. 17 selects the line V102 of the image sensor 101 as an accumulation start object. In addition, by setting Vendsel to Hi at T1, the line V101 of the image sensor 101 is selected as an accumulation complete object. Next, at T2, setting Vend to Hi stops accumulation operations of the line V101. At this point, electric charges accumulated in the line V101 are transferred to the horizontal circuit 1012 through H1, H2, H3, . . . of FIG. 2. At T3, setting Vst to Hi starts accumulation of the line V102. At T4, Hsel is set to Hi, selecting the 101st pixel of the line V101. A pixel signal of the 101st pixel of the line V101 is output at the same time from the horizontal circuit 1012 through the amplifier 1013 in synchronous with clock input to Hpls. In FIG. 17, when Hpls completes clock output up through the 400th pixel, which is at the right end edge of the interest area ImgA, readout processing of the line V101 stops. Accumulation and readout operations are performed using a similar method for the line V102 to the line V200. Thus readout of the interest area ImgA may be performed from the line V101 to the line V200, while readout is not performed for pixels in the horizontal direction for the 401st and subsequent pixels. This differs from the first embodiment, and not performing readout of the 401st and subsequent pixels contributes to a reduction in readout time and an increase in frame rate.

FIG. 18 illustrates a timing chart that illustrates accumulation and readout methods for the line V201 to the line V300 of the image sensor 101. In FIG. 18, accumulation of the line V202 starts after accumulation of the line V201 is stopped, similarly to FIG. 8. Readout processing of the line V201 is performed next. For readout processing of the line V201, the 101st pixel is selected by Hsel, and readout from the 101st pixel to the 800th pixel is performed by Hpls. As shown by Darea of FIG. 18, the interest area ImgA is read out from the 101st pixel to the 400th pixel, and the interest area ImgB is read out from the 701st pixel to the 800th pixel. From the 401st pixel to the 700th pixel, the frequency of Hpls is increased similarly to the skip in reading method illustrated in FIG. of the first embodiment to reduce readout time for unnecessary areas. From the line V202 through the line V300, accumulation and readout are performed similarly to FIG. 18. Thus readout of the interest areas ImgA and ImgB may be performed from the line V201 to the line V300, while readout is not performed in the horizontal direction for the 801st and subsequent pixels. This differs from the first embodiment and not performing readout of the 801st and subsequent pixels contributes to a reduction in readout time and an increase in frame rate.

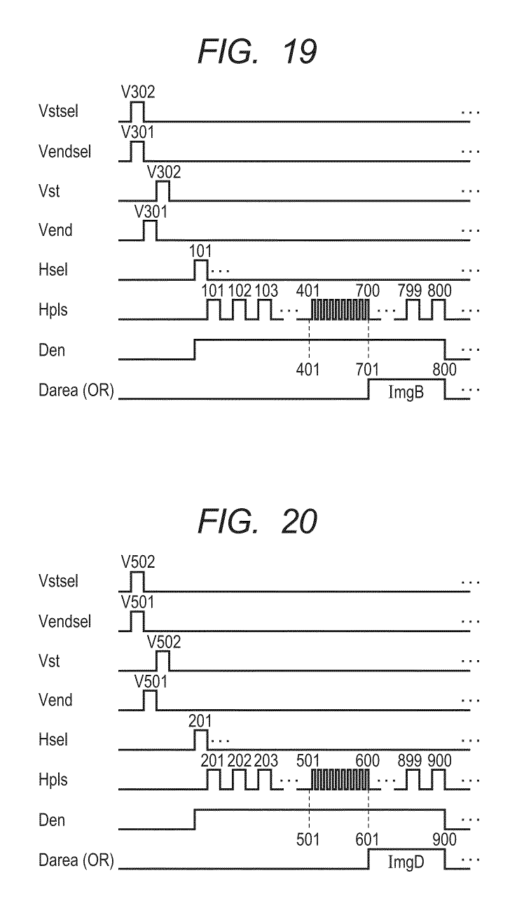

FIG. 19 illustrates a timing chart that illustrates accumulation and readout methods for the line V301 to the line V400 of the image sensor 101. The readout method in FIG. 19 is similar to that of FIG. 18, but Darea differs. Darea becomes Lo at a timing from the 101st pixel to the 400th pixel in the horizontal direction during readout of the line V301. Further, the interest area ImgB exists from the 701st pixel to the 800th pixel in the horizontal direction of the line V301, and hence Darea becomes Hi. Further, similarly to FIG. 18, the frequency of Hpls is increased from the 401st pixel to the 700th pixel to reduce readout time for unnecessary areas.

By thus performing accumulation and readout operations as illustrated in FIG. 17 to FIG. 19, readout of ImgA and ImgB can be performed from the line V101 to the line V400 of Set 1 described above.

Accumulation and readout methods for the line V401 to the line V500 of the image sensor 101 are similar to those in the timing chart illustrated in FIG. 9 of the first embodiment, and a description thereof is thus omitted. By performing V direction skip in reading from the line V401 to the line V500, readout time can be reduced.

From the line V501 to the line V900 of the image sensor 101, accumulation and readout control of the interest areas corresponding to Set 2 described above is performed. FIG. 20 to FIG. 22 illustrate timing charts of readout methods for Set 2.

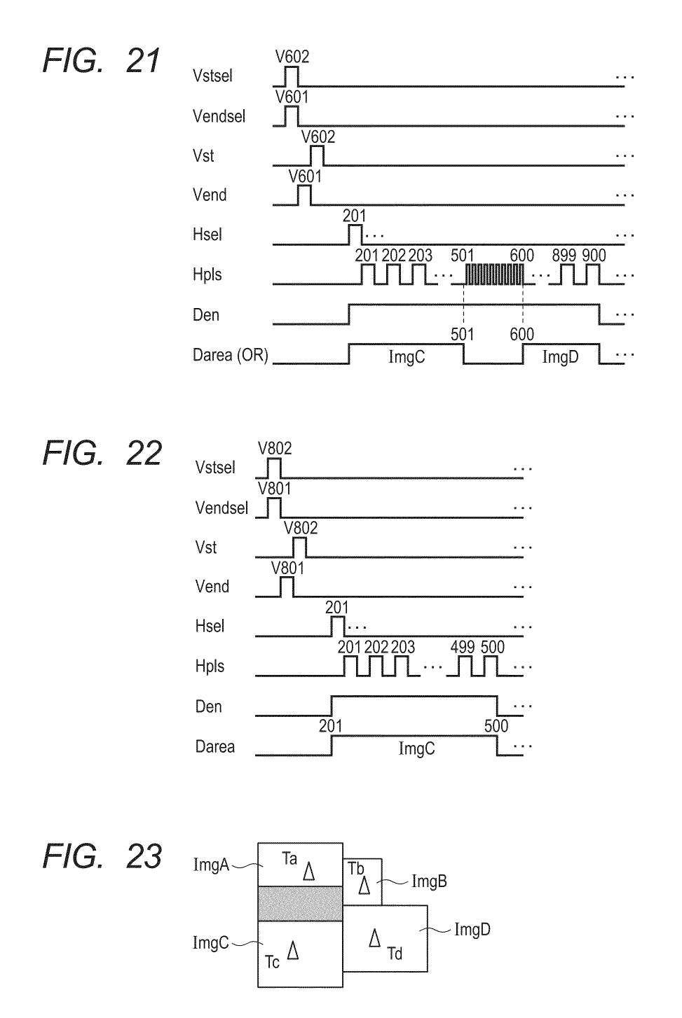

FIG. 20 illustrates accumulation and readout methods for the line V501 to the line V600, and the interest area ImgD is read out. The method illustrated in FIG. 20 is similar to that of FIG. 19, and therefore a detailed description thereof is omitted. Further, FIG. 21 illustrates accumulation and readout methods for the line V601 to the line V800, and the interest areas ImgC and ImgD are read out. FIG. 21 is similar to that of FIG. 18, and therefore a detailed description thereof is omitted. FIG. illustrates accumulation and readout methods for the line V801 to the line V900, and the interest area ImgC is read out. FIG. 22 is similar to FIG. 17, and therefore a detailed description thereof is omitted. In FIG. 20 to FIG. 22, readout thus starts from the 201st pixel in the horizontal direction for each line read out. This is because, in Set 2, the interest area furthest to the left is ImgC, and therefore it is not necessary to read out pixels located further to the left of the 200th pixel.

Accumulation and readout methods for the line V901 to the line V1000 of the image sensor 101 are similar to those illustrated in FIG. 10 of the first embodiment, and a description thereof is thus omitted.

Similarly to the first embodiment, the image signal combination unit 109 of FIG. 1 refers to Darea of the timing charts illustrated from FIG. 17 through FIG. 22. When Darea is Hi, an interest area image signal is obtained, and hence bypass output is performed. Further, when Darea is low, an image signal for an area other than the interest area is obtained, and hence the output is replaced with a black level image signal as dummy data.

Pixel signals obtained by the methods illustrated in FIG. 17 to FIG. 22 in this embodiment as described above are output from the image signal output unit 110 to a portion external to the image pickup apparatus 100. The obtained pixel signals are illustrated in FIG. 23. Compared to FIG. 11 and FIG. 13 of the first embodiment, the readout area can be reduced, the amount of data is reduced, and the frame rate is increased.

In this embodiment, lines that do not exist in any of the interest areas are extracted and the interest areas are divided into a plurality of groups, thus allowing optimal readout methods to be implemented for ImgA and ImgB, and for ImgC and ImgD.

### Third Embodiment

The second embodiment illustrates an example where lines that are not included in any interest area are extracted, the set of lines that are included in each interest area are divided into a plurality of groups, and an optimal readout method is implemented for ImgA and ImgB, and for ImgC and ImgD, thus reducing readout time. That is, the second embodiment shows an optimal example of reducing readout data between interest areas in the horizontal direction. This embodiment shows a method of reducing data between interest areas in the vertical direction.

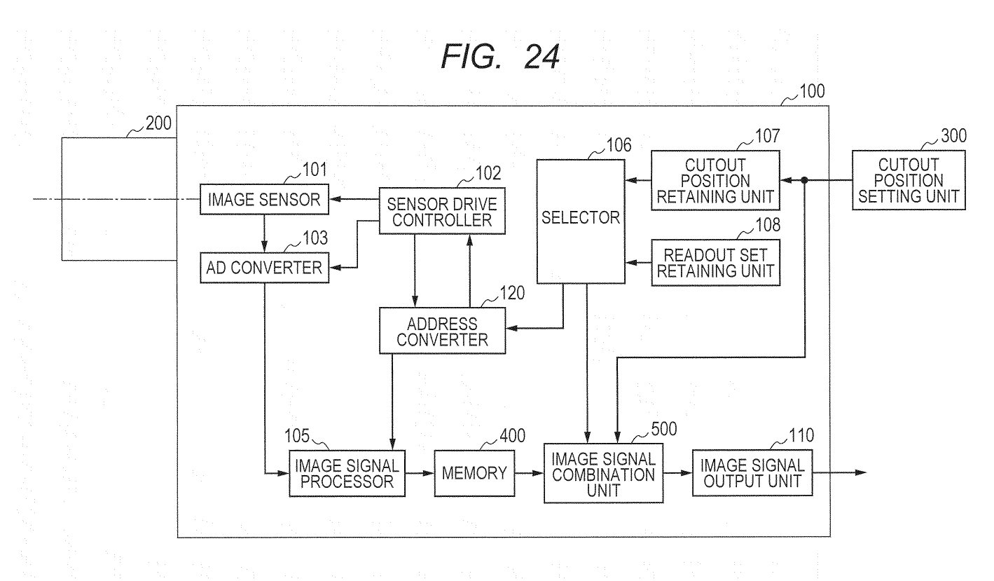

FIG. 24 illustrates a configuration diagram of an image pickup apparatus in this embodiment. The image pickup apparatus of this embodiment includes a memory (pixel signal memory) 400 and an image signal combination unit 500 in addition to the configuration shown by the second embodiment. The memory 400 stores pixel signals output from the image signal processor 105, and performs output to the image signal combination unit 500. The image signal combination unit 500 synthesizes image signals from which unnecessary data areas are removed from the image signals stored in the memory 400, based on interest areas selected by the selector 106. Components other than the memory 400 and the image signal combination unit 500 are similar to those of FIG. 16 of the second embodiment, and a description thereof is thus omitted.

The image pickup composition in this embodiment is the same as that illustrated in FIG. 3 and FIG. 4 of the first embodiment, and a description thereof is thus omitted. Note that, in this embodiment, the number of pixels of a taken image is similar to that of the first embodiment, that is, a width of 1,000 pixels by a height of 1,000 pixels.

Interest areas in this embodiment are similar to those illustrated in FIG. 5 of the first embodiment. In this embodiment, each set interest area is partially read out as in FIG. 5, and portions outside of the interest areas are skipped in reading, thus reducing the amount of read out time.

Processes performed by the address convertor 120, the sensor drive controller 102, the image sensor 101, the AD converter 103, and the image signal processor 105 illustrated in FIG. 24 are similar to those of the second embodiment. Image signals output from the image signal processor 105 are the same as those illustrated in FIG. 23 of the second embodiment. The memory 400 stores image signal data of FIG. 23 output from the image signal processor 105.

Coordinates for each of the interest areas in the image signals of FIG. 23 are shown here. From the timing charts illustrated in FIG. 17 to FIG. 22 of the second embodiment, the coordinates for each of the interest areas are as follows. Each set of coordinates below shows coordinates for upper left and lower right. Information for these coordinates is stored in the memory 400.

ImgA (1, 1) (300, 200)

ImgB (301, 101) (400, 300)

ImgC (1, 401) (300, 700)

ImgD (301, 301) (600, 600)

The image signal combination unit 500 repositions the image signals of each of the interest areas stored by the memory 400 based on the coordinates of each interest area selected by the selector 106. Image signals are then output to a portion external to the image pickup apparatus 100 through the image signal output unit 110.

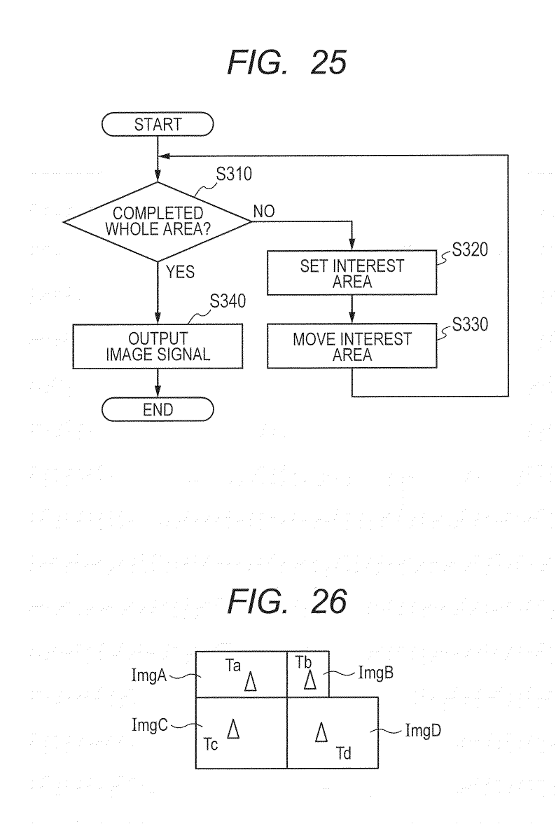

Processes performed by the image signal combination unit 500 are described below using the flowchart of FIG. 25. The image signal combination unit 500 implements the processes in order from Step S310. First, in Step S310, the number of interest areas selected by the selector 106 is confirmed, and whether or not processing of all interest areas has completed is confirmed. When Step S310 is true, processing proceeds to Step S340, while processing proceeds to Step S320 if Step S310 is false. Setting of the interest areas is performed in Step S320. The image signal combination unit 500 stores coordinate information for one interest area from among the interest areas selected by the selector 106. For example, from among the interest areas illustrated in FIG. 5, the coordinates (1, 1), (300, 200) of ImgA are stored by the memory 400. Next, the interest area is moved in Step S330. The image signal combination unit 500 moves the interest area closer to the upper left from the coordinate information of the interest area currently stored. For example, ImgA has the upper left coordinate of (1, 1), and therefore no movement is necessary. Further, taking ImgB as an example, movement is possible by 100 in the vertical direction, and therefore ImgB can be moved to (301, 1), (400, 200). After Step S330 is run, processing returns to Step S310. The coordinates after movement for each of the interest areas are as follows when Steps S310, S320, and S330 are run.

ImgA (1, 1) (300, 200)

ImgB (301, 1) (400, 200)

ImgC (1, 201) (300, 500)

ImgD (301, 201) (600, 500)

Referring back to the description of FIG. 25, after all of the interest areas have been moved, in the step 340, the image signals are output. FIG. 26 illustrates the image signals output here. It can be seen that, compared to FIG. 23 described in the second embodiment, regions where dummy data is output are reduced.

By thus providing the memory 400 and the image signal combination unit 500, unnecessary data that is not all removable by the image signal processor 105 can be reduced, and conformity of the images of each interest area can further be maintained.

Further, the composition of the output image can be computed so that the amount of data (dummy data) other than image data of the interest areas can be reduced to a minimum, depending upon the relationship between the shapes between the set interest areas, by changing the mutual positional relationship between the interest areas. That is, an image to be output may be formed by changing the positional relationship between the interest areas to minimize the amount of output image data (to minimize the area of the formed images). The interest areas can be arbitrarily set by the user with the cutout position setting unit 300, and therefore when the positions of the interest areas are changed to minimize the amount of image data to be output, it is possible that the positional relationship to the original interest areas may become unclear. In such cases, identification information such as coordinates or IDs may be provided to the image data for each interest area in order to make it possible to perform processing necessary to reposition the interest areas with respect to the image received at the image data receiving side.

Further, each interest area set by the cutout position setting unit 300 in the first embodiment to the third embodiment has independent conditions within a viewing screen, as illustrated in FIG. 5. It is also possible that a user may set conditions that allow portions of the interest areas to overlap. When applying the configuration of this embodiment to conditions where portions of the set interest areas are allowed to overlap each other, the conformity of the interest area data in the output image signals can be maintained.

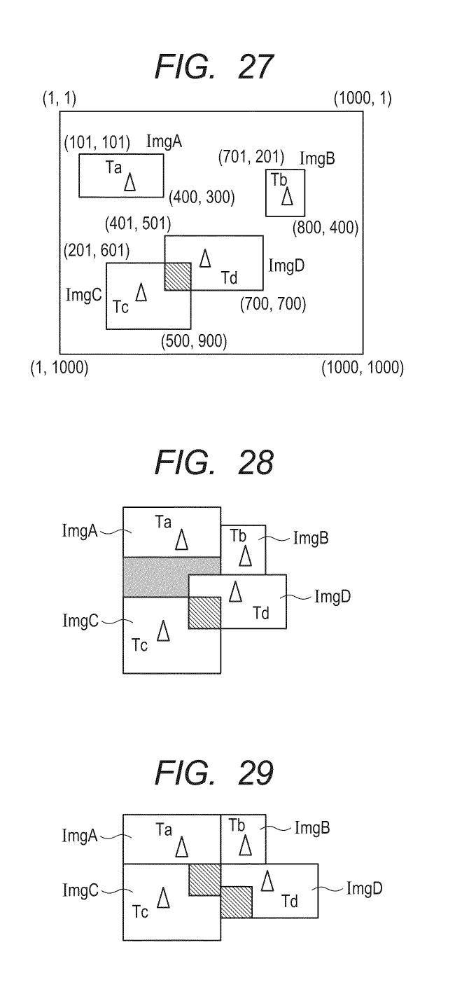

For example, a case where user set interest areas are in the state illustrated in FIG. 27 is described. Note that, a hatched area of FIG. 27 is a region where interest areas overlap. When accumulation and readout of the image sensor 101 are performed using methods similar to those described above, image signals are stored in the memory 400. The image signals at this point are illustrated in FIG. 28. Note that, a hatched area of FIG. 28 is a region where interest areas overlap. At the stage where the image signal processor 105 of FIG. 24 outputs the image signals, control and readout of the image sensor 101 are synchronized, as described in the first embodiment. Data conformity can be achieved by then generating image signals given redundancy in overlapping regions using the image signals stored in the memory 400.

Coordinates for each interest area in the image signals of FIG. 28 are as follows. This coordinate information is stored in the memory 400.

ImgA (1, 1) (300, 200)

ImgB (301, 101) (400, 300)

ImgC (1, 401) (300, 700)

ImgD (201, 301) (500, 500)

When the image signal combination unit 500 implements the flowchart of FIG. 25 described above based on the above coordinates, the coordinates after moving each interest area become as follows.

ImgA (1, 1) (300, 200)

ImgB (301, 1) (400, 200)

ImgC (1, 201) (300, 500)

ImgD (301, 201) (600, 400)

As a result of running the flowchart of FIG. 25, the image signals output from the image signal combination unit 500 are illustrated in FIG. 29. Note that, hatched areas are regions where interest areas overlap, and by running the flowchart of FIG. 25, overlap areas are synthesized in each interest area.

Thus, with the configuration of the third embodiment, even in conditions where set interest areas overlap, conformity of the images of each interest area is maintained, the amount of readout data is reduced, and the frame rate can be increased.

While the present invention has been described with reference to exemplary embodiments, it is to be understood that the invention is not limited to the disclosed exemplary embodiments, and it is possible to make a variety of changes and modification within the scope disclosed. Further, the embodiments described herein may be combined with each other. Note that, although examples involving four interest areas are disclosed herein, the number of interest areas is not limited in present invention, and the present invention can be applied to cases where two or more interest areas exist. Further, although an example of a taken image with a width of 1,000 pixels by a height of 1,000 pixels is described, the image pickup apparatus of the present invention is not limited to this number of pixels.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-088025, filed Apr. 19, 2013, which is hereby incorporated by reference herein in its entirety.

1. An image pickup apparatus, comprising:
a readout area setter configured to set a readout area from which an image signal is read out from the image sensor to maintain shapes of respective interest areas of a plurality of interest areas within an image pickup area of an image sensor in an image formed by an image signal to be output;
a sensor readout controller configured to control readout of a pixel signal of the readout area from the image sensor; and
an output signal generator configured to generate the image signal to be output based on the pixel signal read out by the sensor readout controller.

2. An image pickup apparatus according to claim 1, wherein the readout area setter sets, as the readout area, an area surrounded by a minimum and maximum X-coordinate values and a minimum and maximum Y-coordinate values, from respective coordinates of the plurality of interest areas in a predefined orthogonal XY coordinate system.

3. An image pickup apparatus according to claim 2, wherein the readout area setter sets, as the readout area, an area excluding: an area in which an X-coordinate value is outside an X-coordinate range of any of the plurality of interest areas; and an area in which a Y-coordinate value is outside a Y-coordinate range of any of the plurality of interest areas.

4. An image pickup apparatus according to claim 1, further comprising a pixel signal memory configured to store a pixel signal of each of the plurality of interest areas from among pixel signals read out from the image sensor;
wherein the output signal generator generates an output image signal such that the shapes of the respective interest areas are maintained, based on the pixel signal stored in the pixel signal memory.

5. An image pickup apparatus according to claim 4, wherein the output signal generator generates, based on the pixel signal stored in the pixel signal memory, the output image signal such that the shapes of the respective interest areas are maintained, and such that a size of the image formed based on the generated output image signal becomes a minimum.

6. An image pickup apparatus according to claim 4, wherein the output signal generator generates, based on the pixel signal stored in the pixel signal memory, the output image signal such that images corresponding to interest areas containing mutually overlapping ranges become independent and non-mutually overlapping images for each of the interest areas.

7. An image pickup apparatus according to claim 1, further comprising an interest area setter configured to input a signal in order to set the plurality of interest areas.
